(19) United States
(12) Patent Application Publication
(10) Pub. No.: US 2011/0097134 A1
(43) Pub. Date: Apr. 28, 2011

(54) Radiocontrast Highlighter

(76) Inventors: Eric Evan ALLEN, Simi Valley, CA (US); Edward G. Maliski, Thousand Oaks, CA (US)

(21) Appl. No.: 12/884,891

(22) Filed: Sep. 17, 2010

Related U.S. Application Data
(60) Provisional application No. 61/279,622, filed on Oct. 23, 2009.

(51) Int. Cl. B43K 8/00

(52) U.S. Cl. 401/23

(57) ABSTRACT

The present invention is a class of highlighting devices that contain radiocontrast agents and a carrier medium. These devices may be used to highlight, mark, identify, or map external, but radiotransparent or radiolucent structures so that they are indicated in x-ray radiographic images.

### CROSS-REFERENCE TO RELATED APPLICATIONS

This non-provisional utility patent application claims the benefit of prior filed U.S. provisional application Ser. No. 61/279,622, filed 23, Oct. 2009, which is incorporated herein by reference in its entirety.

### BACKGROUND OF THE INVENTION

1. Field of the Invention

The present invention relates to highlighting devices. More particularly, the present invention relates to highlighting substrate structures for identification in radiographic imaging.

2. Description of the Prior Art

X-ray radiographic imaging is a ubiquitous tool in the fields of human medical imaging, veterinary medicine, transportation security, archeology, food inspection, weld inspection, composite materials assembly inspection, and other forms of non-destructive, non-invasive testing. This is generally true of all x-ray radiographic imaging in that it is used to non-invasively analyze the contents of generic containers, be it human appendages, horse hooves, or boxes and suitcases on a conveyor belt.

Often, x-ray radiographers need to highlight, identify, or map external, radiotransparent or radiolucent structures to provide reference positions to where these structures are indicated in x-ray radiographic images. An example would be marking external measurements on a human's arm so that the external marks will show up overlapped with the x-ray radiographic image of the bones and any other radio-opaque materials that may lie within the appendage. An x-ray radiographer may wish to write freehand on a piece of tape and place the tape on an x-ray film cassette or on the outside of a box, piece of luggage, or other container going through an x-ray radiographic imaging device to place written information into the image in a convenient manner compared to affixing lead-block-alphanumerics to the outside of the cassette, box, luggage, or other container.

### SUMMARY OF THE INVENTION

The present invention relates to radiocontrast highlighting devices.

It is an object of this invention to provide a radiocontrast highlighter for outlining, tracing, identifying, tracking, or mapping external structures to internal structures revealed by x-ray radiographic imaging.

Yet another object of this invention to provide a radio-opaque highlighter, including at least one radio-opaque highlighter medium and a writing tool.

A further object of this invention is to provide a radio-opaque highlighter medium including at least one radiocontrast agent and a carrier medium; the highlighter medium applicable to a surface by a writing tool.

Accordingly, a broad embodiment of this invention is directed to a radio-opaque highlighter including at least one radio-opaque highlighter medium and a writing tool, the medium comprising at least one radiocontrast agent and a carrier medium, and the highlighter medium applicable to a surface by the writing tool.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a drawing of one embodiment of the present invention.

FIG. 2A shows the visible characteristics of a series of embodiments of the present invention.

FIG. 2B shows the radio-opaque characteristics of the series of embodiments of FIG. 2A.

FIG. 3 is a drawing of another embodiment of the present invention.

FIG. 4 is a photograph and corresponding radiograph of an embodiment of the present invention used on a human torso.

FIG. 5 is a photograph and corresponding radiograph of an embodiment of the present invention used on a human hand.

FIG. 6 is a photograph and corresponding radiograph of an embodiment of the present invention used on a lamb leg.

### DETAILED DESCRIPTION

Referring now to the drawings in general, the illustrations are for the purpose of describing a preferred embodiment of the invention and are not intended to limit the invention thereto.

Heretofore, no satisfactory highlighting tools exist for highlighting the external, radiotransparent or radiolucent substrate structures through which x-rays normally pass unimpeded in the manner so described above. Existing marking methods include barium sulfate paste as a marking medium, lead alphanumeric blocks and tape, and wire and tape. These existing methods are inconvenient and/or imprecise. Thus, a need exists for a radio-opaque highlighting tool that overcomes the limitation of the prior art.

The present invention is a radio-opaque highlighting device that includes at least one radiocontrast agent mixed in a carrier medium to form a radio-opaque highlighter medium, the highlighter medium contained in a writing tool. The radiocontrast agent can be any radio-opaque agent that is safe for use in medical applications. In a preferred embodiment, the highlighting device uses radiocontrast agents already in use in the medical field, including contrast agents such as, but not limited to, tungsten (CAS # 7440-33-7), bismuth (CAS # 7440-69-9), tantalum (CAS # 7440-25-7), and barium sulfate (CAS # 7727-43-7).

The carrier medium can be any medium that can be used in handwriting instruments, such as in crayons, pencils, gel pens, ink pens, brushes and the like. The carrier medium thus includes, but is not limited to, waxes, gums, gels, glycans, fats, oils, long-chain alcohols, long-chain esters, parafins, polymers, dyes, pigments, colorants, starches, solvents, and the like and any of the materials commonly used in making cosmetics.

The writing tool can be any writing tool that can hold and deliver the highlighter medium in a writing manner. For example, grease pencils, lipstick-type embodiments, lip-liner type embodiments, solid eye-liner type embodiments, gel pens, and liquid eyeliner-type embodiments can be used to apply a sufficient quantity of the highlighter medium in a controlled, writing manner. The writing tool is furthermore of a dimension that is easy to hold and write with, similar in diameter to a white-board erasable marker or a carpenter's pencil. In a grease pencil embodiment, a soft, solid waxy core is supported by a paper or other rigid wrapping material that peels away to reveal more writing tip. This more rugged embodiment may be preferable for industrial applications. In a lipstick-type embodiment, the highlighter medium is soft and easy to apply to skin. This embodiment may also be preferable for applications requiring broad lines. In a gel pen embodiment, a plastic, ceramic, metal or similar roller tip feeds a smooth, continuous flow of ink to the surface to be written upon. This embodiment provides a finer point for more detailed applications. A liquid eyeliner embodiment provides an easy-to-apply highlighter medium, much like a controlled paint that dries quickly and will not smudge or melt once applied. Other embodiments include a tip that can deliver the liquid but write more like a fiber-tip marker.

A radio-opaque highlighter according to the present invention provides for drawing lines that are radio-opaque and also visible in normal light, dense and continuous with no breaks or skips, and lines that are about 2.5 mm or wider with a clear edge or border that does not have fuzzy or ragged edges, both in the visible and X-ray spectra.

The highlighter medium preferably does not smear or spread with body heat while the X-rays are being taken; is washable and easily removable with water and a surfactant or a readily available solvent such as isopropanol; is non-toxic and non-irritating to the skin; and has low or no toxicity if accidentally ingested and low/no toxicity if accidentally introduced through a wound.

Furthermore, the delivery of the highlighter medium is smooth and continuous when writing, that is, the user is able to mark the object without having to resort to re-dipping the tip as is necessary when painting or using a quill pen; the highlighter medium flows quickly enough from the writing point onto the object in order to permit a natural pace of writing, about 4 letters per second or 3 cm of drawn line per second; the delivery action does not pull the skin excessively nor requires pressure to leave a mark on the skin, in order to make it comfortable to draw on a people who may already be injured and in pain. For veterinary applications, the embodiment is designed to accommodate writing on hair or fur.

Thus, a method of highlighting radiographs according to the present invention includes the method steps of 1) providing a radio-opaque highlighter, the highlighter including at least one radio-opaque highlighter medium and a writing tool, the medium including at least one radiocontrast agent and a carrier medium, and the highlighter medium applicable to a surface by the writing tool; 2) applying the highlighter medium to the object to be radiographed; and 3) radiographing the object; thereby highlighting the radiograph. The method preferably further includes a highlighter medium that is sufficiently radio-opaque to be discernible on a radiograph and sufficiently radiolucent to permit viewing of the field of interest.

The highlighter is preferably storable without clogging, jamming, or breaking down for a period of up to one year such as a pencil, crayon, grease pencil, or capped pen; is ready to use when un-capped for use like a capped pen, gel, pen, or crayon; is easy to maintain a point capable of making about a 2.5 mm mark or greater, is “non-flammable”, and “shelf stable”, that is, cannot oxidize easily, dry out, or harden when stored over time (up to five years) when capped; is “shelf stable” when stored at warehouse temperatures (−10 C to 40 C). For medical patients, some models should be single-use to avoid communicating contagions.

The present invention advantageously provides for: (a) The ability to highlight and mark x-ray film cassettes directly with identifying labels and more detailed notes without having to assemble lead block markers. (b) The ability to highlight and mark x-ray film cassettes by writing on tape, paper, or other material that may be affixed to the x-ray film cassette with identifying labels and more detailed notes without having to assemble lead block markers. (c) The ability to highlight and mark radiotransparent or radiolucent surfaces so that the surface will show up in the x-ray radiograph. (d) The ability to write freehand information, notes, drawings, location marks on radiotransparent or radiolucent surfaces so that these features will show up in the x-ray radiographs.

The materials from which the radiocontrast media are concocted are low or non-toxic, are generally recognized as safe, and do not have any hazardous material disposal issues or requirements.

Different highlighting devices advantageously have differently colored inks, pigments, or colorants thereby assisting color differentiation of visible features in visible-light photographs. These may be used to contrast visible-light photographs with x-ray radiographs of the same physical structures.

Freehand markings and/or grid pattern designs can be applied to the patient's skin at the time of the initial examination using the present invention, to identify critical areas such as areas of pain, sensitivity, or entry points of foreign objects, providing radiocontrast images to easily pinpoint areas of focus for medical evaluation of the patient's body;

Utilization of highlighting devices by the original examining physician effectively identifies, distinguishes, and aides in preliminary analysis of the critical area(s) of concern, directing the attention of subsequent viewers of the radiographs to the primary areas of concern, thus reducing the necessity for subsequent radiography by secondary physicians who may be called into a case analysis. This enhanced form of communication between the examining physician and subsequent viewers could lead to a reduction in potential errors in the reading of x-ray radiographs.

The present invention provides advantages over prior art methods. For example, it is quickly and easily applied by the examining physician, whereas other methods are cumbersome and time-consuming to use. The highlighting also remains secure during patient positioning and x-ray radiography. In particular, it remains in a fixed position relative to the skin during repositioning for different positional views. Prior art methods are not necessarily secure. The highlighter according to the present invention conforms to irregular anatomical topography. It also has a radiocontrasting component which is radio-opaque enough to be readily apparent to the examining physician and the radiologist, but radiolucent enough so as not to obscure the field of interest, as most prior art methods frequently do. Also, the present invention provides an easy and pain-free ability to execute grid type designs on soft tissue (such as breast tissue) to highlight specific areas for interpretation of X-ray radiographs. The carrier medium is also steadfast enough that it can be used over a multi-day period, providing a common reference point for subsequent radiography to measure specific progress.

Additional advantages provided by the present invention include: Reducing the number of missed lesions, such as fractures, with resultant inadequate treatment; reducing excessive attempts at clarification of areas of questionable radiographic significance, but of no clinical significance, resulting in increased radiation, cost, and discomfort to the patient; reducing the loss of time in critical situations, resulting from the need to repeat x-rays; providing the ability to identify areas of concern prior to a surgical procedure executed in a sterile environment. Once the area is highlighted it can be draped over and protected for operating. Mid-surgery x-rays could be taken to provide extremely accurate updates of highlighted areas without compromising the draped area. The present invention also advantageously can reduce surgical time, minimize margin of error, and aide in more precise diagnosis and follow-up. The radiocontrast marking also has a configuration that cannot possibly be mistaken for a foreign body and the highlighter application is non-irritating to the patient, and is easily removable with isopropyl alcohol or soap and water. The highlighter application is very low in cost relative to the improved interpretation and problem avoidance due to improper diagnosis, as mentioned hereinabove.

There are often no surface anatomical features on a patient's body adequate to use as reference points (e.g. such features may not exist or may not be located appropriately for such use). If there are no anatomical reference points on the surface of a patient's body, one is unable to precisely locate a target site or structure shown in a two dimensional diagnostic image. The location of the target site or structure is obscure because the two-dimensional diagnostic image does not provide sufficient information for a geometric relationship between a surface point on the patient's body and the target site or structure to be accurately calculated. Points of concern where x-rays are imaging bone over bone (such as torso shots where frontal and rear ribs are in same x-ray radiograph), can be highlighted with the present invention. Points of pain and/or wound entry points that are otherwise invisible on an x-ray radiograph can be easily highlighted with the present invention.

### Examples Embodiments of the Present Invention

The following examples are provided for illustration purposes only, and are not meant to limit the invention in any way.

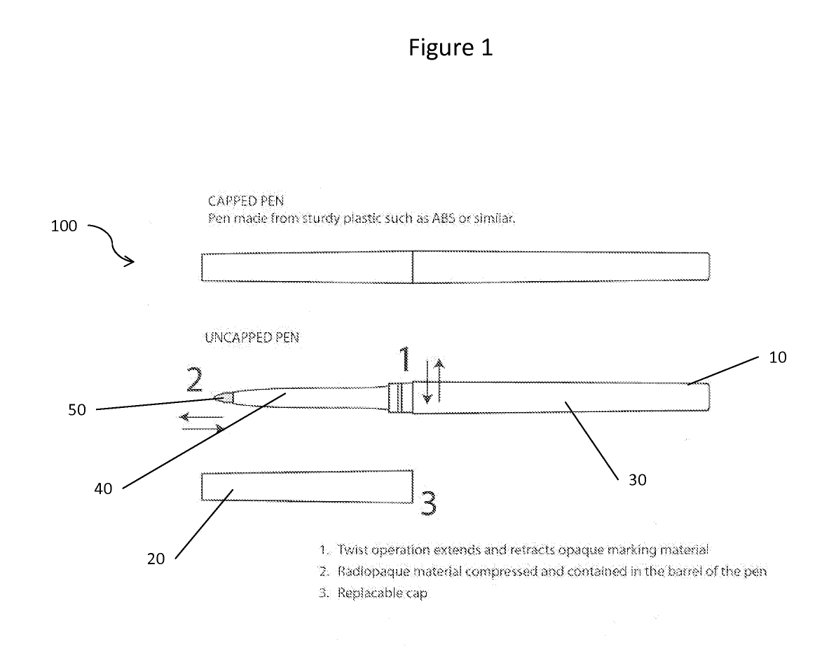

FIG. 1 describes a writing tool embodiment used in the present invention. The writing tool, generally described as 100 includes a body 10 and a cap 20. The body 10 includes a barrel 30 which is a reservoir for holding the radiohighlighter medium. The body further includes a feed section 40 that feeds the radiohighlighter medium to the point 50. The feed section twists in relation to the barrel. The twisting action retracts and extends the point.

Various types and concentrations of radiocontrast agents were tested in various carrier mediums. The results follow:

Bismuth was dispersed in Rimmel London #180 lipstick in concentrations from 20-50% by volume. It was discovered that if the bismuth is too concentrated, the highlighter does not hold together. Concentrations at or below 50% by volume gave acceptable results.

Bismuth disbursed in face paint crayon at 50% by volume gave acceptable results.

Iohexol dissolved in face paint crayon at 50% by volume did not provide radio-opacity sufficient for any practical use.

Tantalum grit combined with lipstick was found to be too coarse. Grinding the tantalum grit into flour provided excellent results. Particle size is between about 10 microns and about 100 microns.

Peptobismol, a solution of bismuth subsalicylate (262 mg/15 mL), was found to be not sufficiently radio-opaque.

Another embodiment of the present invention is an eyeliner pen embodiment. This embodiment has the form factor and size that fit easily in the hand and produced a line that was useful for highlighting surface features in medical diagnostic radiographs.

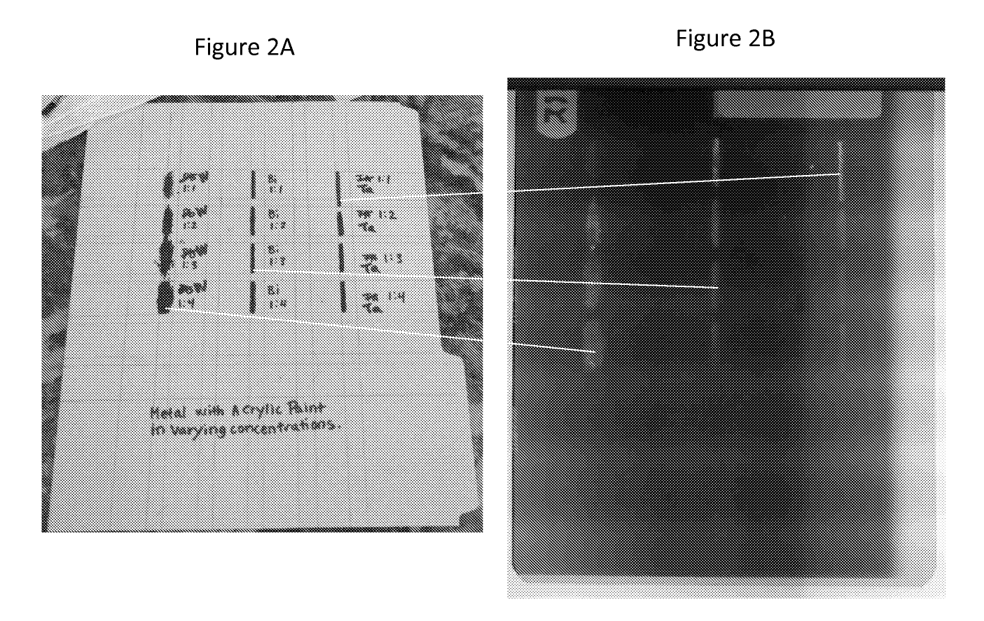

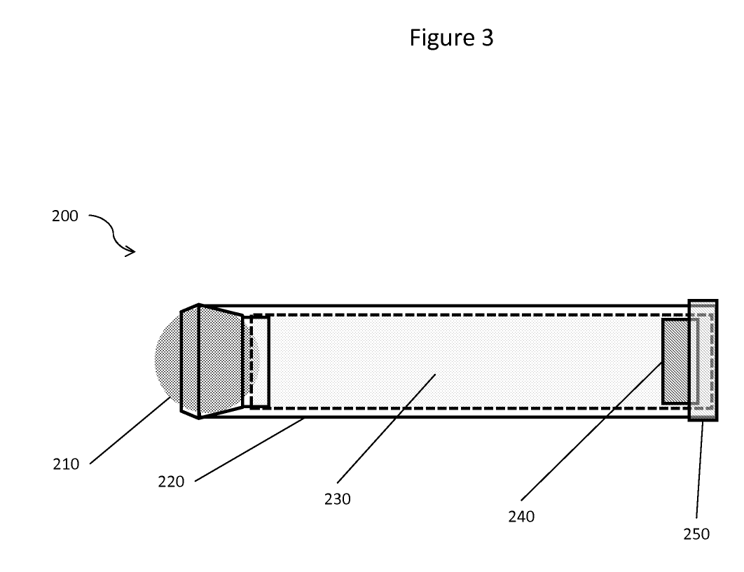

A series of embodiments of tantalum in paint were also tested. Tantalum was diluted in ratios of 1:1 to 1:4 in white poster paint. The paint was not quite thick enough for the majority of applications. Next, tantalum, bismuth and tungsten were diluted separately in thick acrylic paint, PLAID Enterprises, 484 Brilliant Ultramarine, and applied with a paint brush, or with a toothpick, as was the case with the tungsten. Toothpick application did not give uniform line thickness. This embodiment gave acceptable results. Dilutions tested were 1:1, 1:2, 1:3, and 1:4. Results are shown in FIGS. 2A and 2B. When more uniformly applied with a paintbrush, the dilutions gave intuitive increasing line brightness with increasing metal concentration.

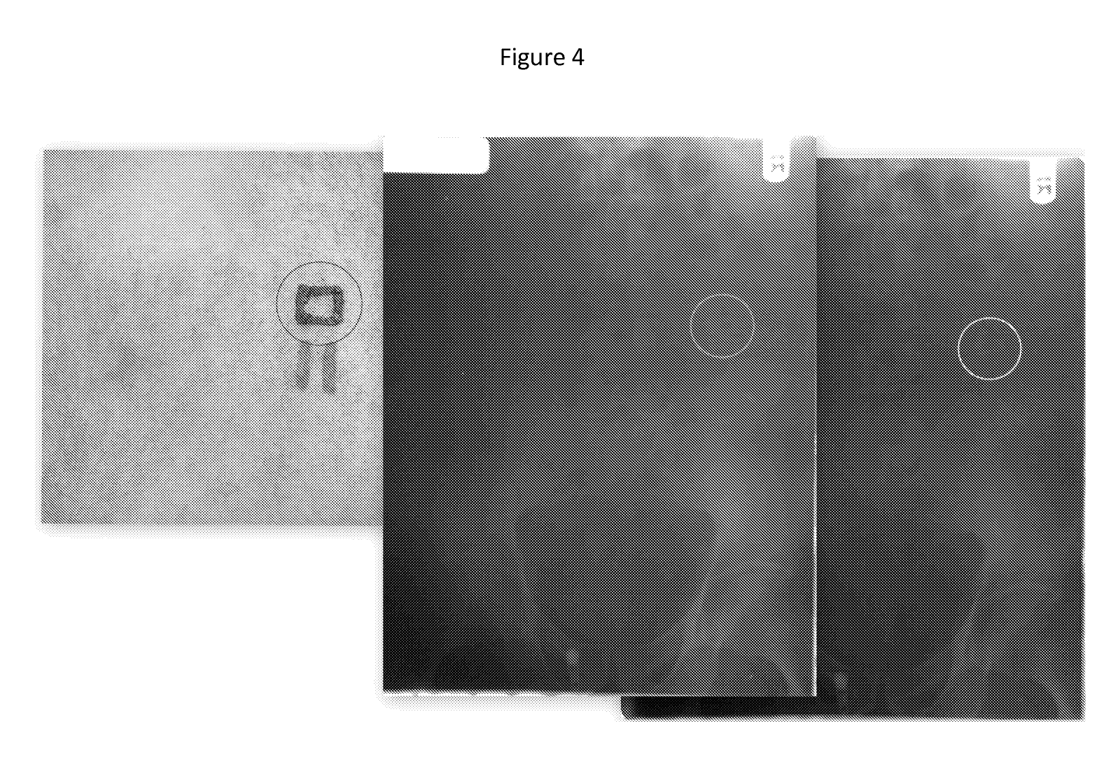

Another embodiment of the present invention, as shown in FIG. 3, includes a roller ball pen, generally described as 200, with a roller ball point 210 housed in a body 220 containing a removable ink cartridge 230 filled with a radiohighlighter medium including a radiocontrast agent and an acrylic paint carrier medium, the radiohighlighter medium held in the cartridge by an ink follower 240. The pen is preferably refillable, with an endcap 250 that allows for replacement of the cartridge. The roller ball point is sufficiently large to produce an adequate width line for radiography applications. A ⅜ inch roller ball point was tested and found to give acceptable results.

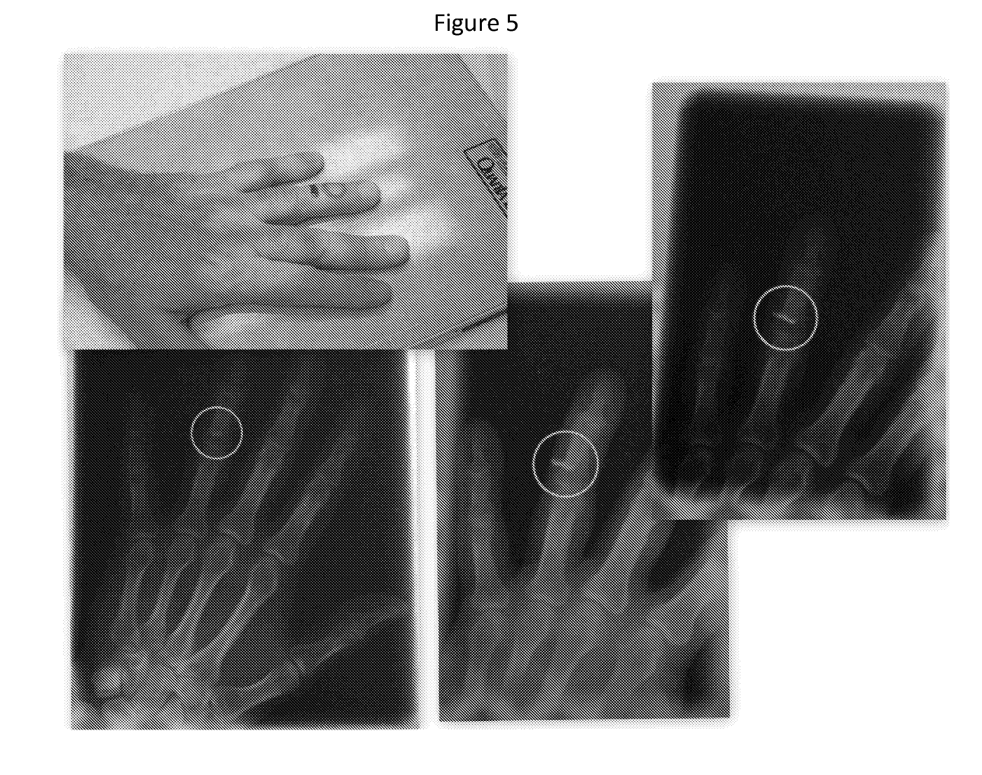

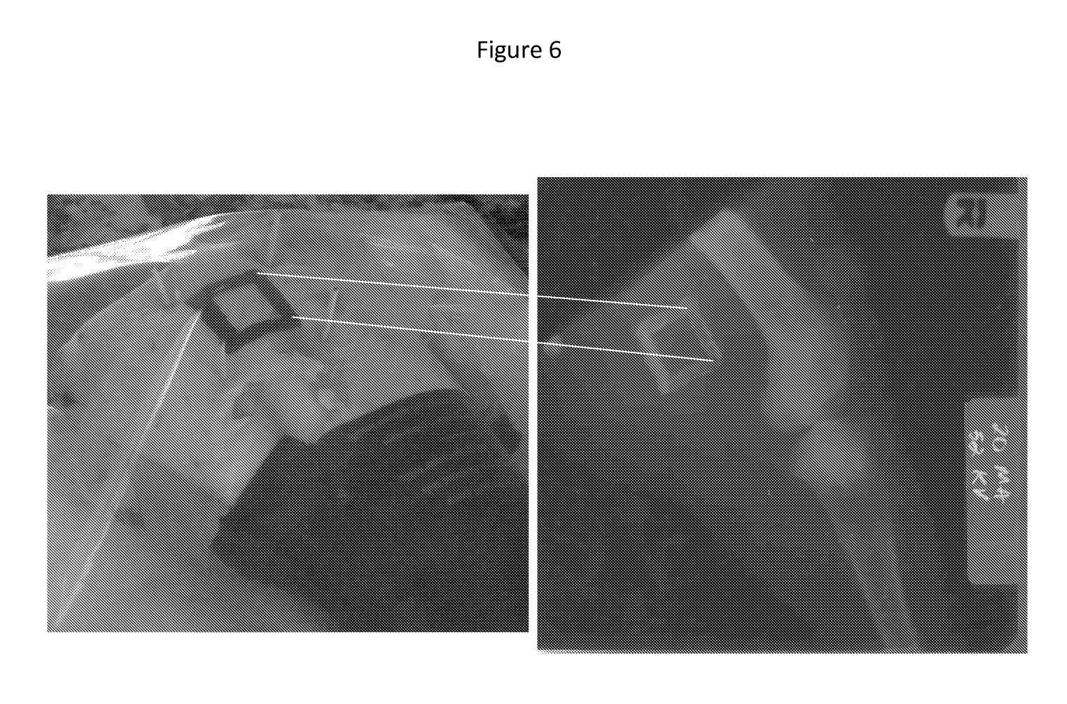

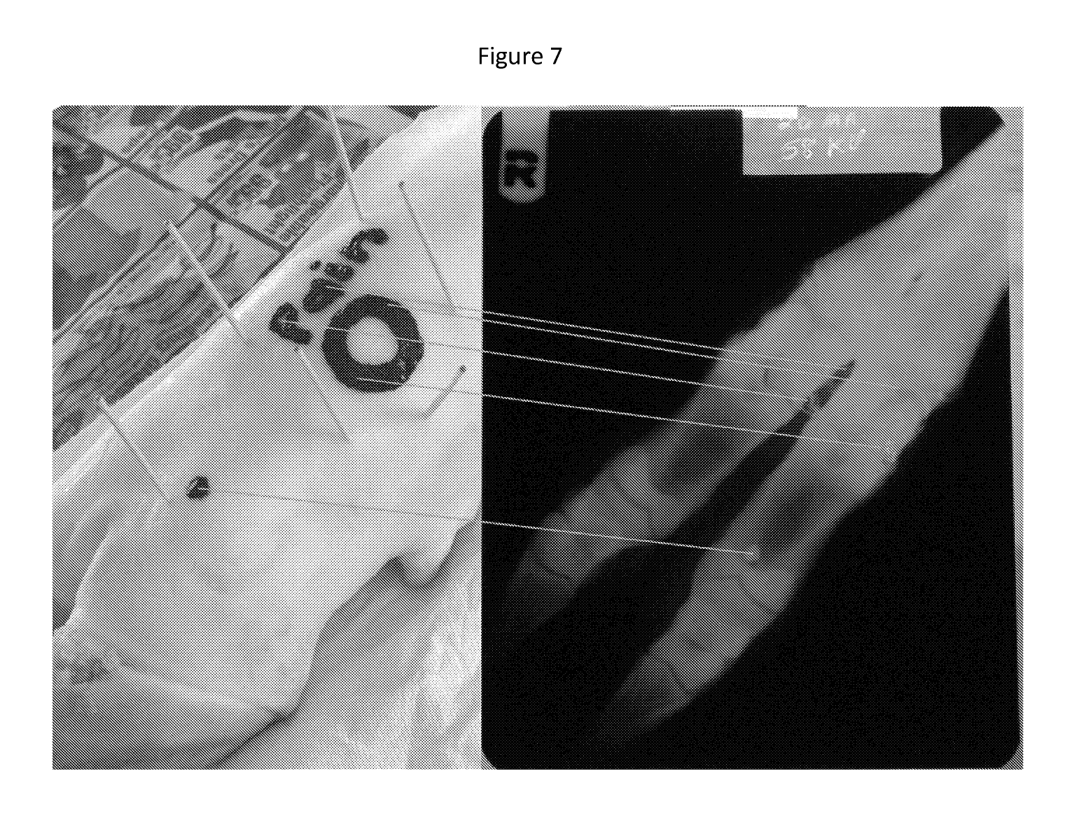

Other embodiments that worked include tungsten 50% by volume in paint or lipstick, which is visible in a chest radiograph, hand radiograph, and radiograph of a lamb leg (FIGS. 4, 5, and 6, respectively). Tungsten 25% by weight in a Schwann-STABILO marker did not produce marks that were adequately radio-opaque. Table 1 shows the results of experiments using tungsten at different concentrations and on different body parts. The 50% tungsten highlighter was 50% by volume tungsten in Rimmel London #180 lipstick, dispensed from a truncated and coned 0.3 mL syringe.

TABLE 1
Tungsten experiments

| | SureMark mole | 25% (by weight) | 50% (by volume) |
|---|---|---|---|
| Anatomical | stick-on | Tungsten | Tungsten |
| Entity | mole marker | highlighter | highlighter |
| Pork | Barely visible | Not Visible | Nicely Visible |
| Shoulder | over soft tissue; | | |
| | invisible over bone | | |
| Human Hand | N/A | Not Visible | Nicely Visible |
| Human | N/A | Not Visible | Nicely Visible |
| Abdomen | | | |

Many different formulations can be made to provide the characteristics of the present invention. For example, radiocontrast dyes such as iohexol (CAS#66108-95-0), urografin (CAS# 117-96-4) and gastrografin can be used in the present invention. Some example formulations according to the present invention follow. Another embodiment of the present invention uses any acceptable iodine-based radiocontrast agent, such as triiodophenol, alone or in combination. These had inferior radiocontrast properties compared to the metal-containing formulations.

An iohexol formulation was developed and tested. The formula is shown in Table 2.

TABLE 2
Iohexol formulation

| Material | CAS# | Quantity | |
|---|---|---|---|
| Iohexol | 66108-95-0 | 250-500 | mg |
| Water | | 1 | mL |
| Diacetone alcohol | | 1 | mL |
| 1-propanol | | 2 | mL |
| Nigrosine (alc. Sol.) | 11099-03-9 | 250 | mg |
| 1-butanol | | 1 | mL |

Water, diacetone alcohol, 1-propanol, 1-butanol, and iohexol were combined and mixed until in solution. Nigrosine was then added and the mixture sonicated.

This ink was loaded into an empty, COPIC Fiber-tip pen. The ink made uniform and well-formed lines, but was not suitably radio-opaque.

Different visible dyes can be used in the same formula. For example, Orcosolv Blue 2GN (250 mg) or Keystone Morfast Blue 105 (5 mL) can be substituted for the nigrosine dye.

Another formula combines 2.0 g triiodophenol (CAS# 609-23-4) in 2.0 mL xylenes and 2.0 mL diacetone alcohol. Once warmed and dissolved, 0.55 g solvent blue 35 and an additional 0.5 mL each of the xylenes and diacetone alcohol are added and the solution warmed again to complete dissolution.

This ink was loaded into an empty, COPIC Fiber-tip pen. The ink made uniform and well-formed lines, but was not suitably radio-opaque.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

What is claimed is:

1. A radio-opaque highlighter, comprising:
a. at least one radio-opaque highlighter medium and a writing tool, the medium comprising at least one radiocontrast agent and a carrier medium, and the highlighter medium applicable to a surface by the writing tool.

2. The highlighter of claim 1, wherein the writing tool is selected from the group consisting of pens, pencils, and brushes.

3. The highlighter of claim 1, wherein the at least one radiocontrast agent is selected from the group consisting of tantalum, tungsten, bismuth, and barium sulfate.

4. The highlighter of claim 1, wherein the at least one radiocontrast agent is an iodine-based compound.

5. The highlighter of claim 4 wherein the iodine-based compound is selected from the group consisting of iohexol, gastrographin, urographin, and triiodophenol.

6. The highlighter of claim 1, wherein the at least one radiocontrast agent is a powder.

7. The highlighter of claim 1, wherein the carrier medium is selected from the group consisting of waxes, gums, gels, glycans, fats, oils, long-chain alcohols, long-chain esters, paraffins, polymers, dyes, pigments, colorants, starches, and solvents.

8. The highlighter of claim 1, wherein the writing tool includes a roller ball pen with about a ⅜ inch roller ball.

9. The highlighter of claim 1, wherein the highlighter medium is sufficiently radio-opaque to be discernible on a radiograph and sufficiently radio-lucent to permit viewing of the field of interest.

10. A radio-opaque highlighter medium comprising at least one radiocontrast agent and a carrier medium; the highlighter medium applicable to a surface by the writing tool.

11. The highlighter medium of claim 10, wherein the at least one radiocontrast agent is selected from the group consisting of tantalum, tungsten, bismuth, and barium sulfate.

12. The highlighter medium of claim 10, wherein the at least one radiocontrast agent is a powder.

13. The highlighter of claim 10, wherein the at least one radiocontrast agent is an iodine-based compound.

14. The highlighter of claim 13 wherein the iodine-based compound is selected from the group consisting of iohexol, gastrographin, urographin, and triiodophenol.

15. The highlighter of claim 10, wherein the carrier medium is selected from the group consisting of waxes, gums, gels, glycans, fats, oils, long-chain alcohols, long-chain esters, paraffins, polymers, dyes, pigments, colorants, starches, and solvents.

16. The highlighter of claim 10, wherein the highlighter medium is sufficiently radio-opaque to be discernible on a radiograph and sufficiently radiolucent to permit viewing of the field of interest.

17. A method of highlighting radiographs, the method steps comprising:
a. providing a radio-opaque highlighter, the highlighter comprising at least one radio-opaque highlighter medium and a writing tool, the medium comprising at least one radiocontrast agent and a carrier medium, and the highlighter medium applicable to a surface by the writing tool;
b. applying the highlighter medium to the object to be radiographed;
c. radiographing the object;
thereby highlighting the radiograph.

18. The method of claim 17, wherein the highlighter medium is sufficiently radio-opaque to be discernible on a radiograph and sufficiently radiolucent to permit viewing of the field of interest.
